(19) United States
(12) Patent Application Publication
(10) Pub. No.: US 2006/0004869 A1
(43) Pub. Date: Jan. 5, 2006

(54) System and method for mapping relationship management intelligence

(75) Inventors: Joshua Todd Yuster, San Francisco, CA (US); Doug Wayne Dalton, San Francisco, CA (US)

Correspondence Address: PILLSBURY WINTHROP SHAW PITTMAN LLP, P.O. BOX 10500, MCLEAN, VA, 22102, US

(73) Assignee: BranchIT, Inc., San Francisco, CA (US)

(21) Appl. No.: 11/111,107

(22) Filed: Apr. 20, 2005

Related U.S. Application Data
(60) Provisional application No. 60/564,245, filed on Apr. 20, 2004.

(51) Int. Cl. G06F 17/00

(52) U.S. Cl. 707/104.1

(57) ABSTRACT

The present invention discloses a system and a method for identifying individuals within an organization that are familiar with a target person outside of the organization. Additionally, the present invention includes a system and means for updating the data as identified below in situations where new contacts occur, when companies share relationship information, or when companies merge. For example, a data center can query and pull information from a selected company

### CROSS REFERENCE TO RELATED APPLICATION

This application claims the benefit of U.S. Provisional Application No. 60/564,245, filed Apr. 20, 2004 (Atty. Dkt.: 016346-0309288) entitled “SYSTEM AND METHOD FOR MAPPING RELATIONSHIP MANAGEMENT INTELLIGENCE”.

### FIELD OF THE INVENTION

The present invention relates generally to the field of data management and, more specifically to, business intelligence, enterprise search, social networking, and customer relationship management used to develop data for enterprise relationship management.

### BACKGROUND OF THE INVENTION

Networking typically occurs on a verbal level. Known systems lack sufficient means for allowing members of an organization to share knowledge relating not just to what they know, but also to who the members know. Furthermore, known systems are inadequate for tracking whom everyone within the enterprise “knows” as well as finding ways to share that information without jeopardizing or diluting these relationships.

It is known that a valuable asset of an organization or a company is the members or employees in light of the aggregate relationship of each of those individuals with individuals outside of the organization, on both a professional and personal level. In essence, whom a given employee knows is valuable information that can be utilized by the organization. It is to the benefit of the organization, as well as the members or employees, to utilize the relationships that already exist to form and create new relationships with people outside of the organization.

Various methods and systems currently exist that allow an organization to facilitate introductions that may result in the formation of new relationships between people inside the organization or company for the benefit of forming new relationships to individuals outside of the organization or company.

For example, known systems allow a requestor to send a request to one or more individuals in the organization to inquire about a particular relationship that may exists between other members of the requestor's organization and an individual outside of the organization. However, these systems lack the ability to keep either or both the identity of the requestor and the individual with the connection anonymous relative to the other person.

Other known systems attempt to find a relational path between the requestor within the organization and the targeted person outside the organization by identifying various links that connect the requestor to at least one other individual in the organization who knows a third-individual in the organization who knows a fourth-individual in the organization, and so on, until the final person is reached in the organization, which may be up to six degrees of separation or more, familiar with the targeted person outside the organization. However, the problem with this approach is that many individuals are involved instead of just the individual at the end of the chain within the organization, which results in an inefficient and often ineffective process, especially when there is little motivation for the members of the organization to respond to others in the chain and eventually to the requester.

Alternative methods exist, such as use of electronic mail or e-mail, wherein the requestor generates a request in the form of an email to the members of the organization. The requestor queries a set group or potentially the entire organization hoping to get a response from other members of the organization familiar with the targeted person outside of the organization. However, such an approach not only lacks anonymity but also results in numerous emails being generated, which can increase exponentially. Furthermore, there is no effective means of evaluating the relationships. Also, this approach lacks the ability to quantitatively measure the effectiveness of this system in light of the burden on the system and the members of the organization.

Thus, what is needed is a system and method that can identify individuals within an organization who are familiar with a targeted person outside of the organization. Furthermore, the system should be able to evaluate the strength of the relationship based on statistical data and present the information about the strength of the relationship between the individuals in the organization and the targeted person to a requestor. Such relationship data should be presented to the requestor while maintaining the anonymity of the other individuals within the organization with a relation to the targeted individual outside of the organization. Furthermore, what is needed is a system and method that will also allow the requestor to remain anonymous to the individual or individuals receiving the request, if so desired. The state of anonymity should continue until it is determined that the member of the organization or the requestor or both chooses to be identifiable by the other.

### SUMMARY OF THE INVENTION

The present invention discloses a system and a method for identifying individuals within an organization that are familiar with a target person outside of the organization. Such data is presented to the requestor and the system is capable of maintaining the anonymity of either or both the individual of the organization receiving the request and the requester, unless and until it is determined that the individual and/or the requestor are to be identified to each other. Additionally, the present invention includes a system and means for updating the data as identified below in situations where new contacts occur, when companies share relationship information, or when companies merge. For example, a data center can query and pull information from a selected company.

One advantage of the present invention is that the identity of both parties involved in creating a connection, such as the requester and the individual having the relationship with the target individual, can be kept anonymous until each respective party chooses to reveal his or her identity or such identity is revealed by the system administrator.

Another advantage of the present invention is that it can weigh and rank relationships based on prior system usage. The present invention includes knowledge management, business intelligence, and search technologies and is directed to a method and system for collecting user relationship information, mapping relationship information, scoring relationship information, and providing a platform for connecting users together to share relationship information in a secure, non-invasive means.

Yet another advantage of the present invention is the ability to include incentives for participation in the relationship management system to tie to an incentive either at a company level, at an individual level, or at a search level whereby the incentive may either be pre-set or may be negotiated by the parties involved.

Still another advantage of the present invention is aimed at not only “hunting” down and uncovering relationship management intelligence that already exists within the organization but also at facilitating control over relationships, enabling the organization to make them more plentiful, and higher quality, over time by enabling the “farming” of relationship networks. In this way, the person with the relationship retains some degree of control and, hence, a greater level of trust.

The advantages of the present invention are achieved without the need to load or place software on each individual system or user system located at the organization. The software that extracts the relationship information can be remotely located. This provides many advantages including the ability for a customer to get up and running quickly, without relying on their IT-department to install software in-house. Also, amongst other things, new features can automatically be pushed out to customers without patches needing to be installed at the customer.

One application for such a system and method is in the area of sales-based enterprises, where the difference between a cold call and a warm lead when going into a sales call can be significant. Specifically, organizations looking to develop more channels for their products, those in high-growth markets where sales cycle speed is paramount in a “land grab” environment, would greatly benefit from using every resource available to find these warm leads. Secondly, sales-based organizations within already tightly competitive markets, where every bit of marginal information can help increase close rates and pump up revenues, would also stand to win out from gaining extra insight.

Other areas of application include the field of human resource management. The process of finding and hiring the right candidate, for example, can be costly and such cost would be significantly reduced by using relationship management information in accordance with the teachings of the present invention to search out hires, in lieu of paying expensive recruiters and headhunters, and to check an applicant's reference.

In addition, organizations recently acquiring other companies can benefit from a smoother merger-integration process. Rather than relying on scheduled meetings or informal conversations to establish who knows whom, the information becomes available immediately after the data from the acquired company's systems are cataloged.

Another aspect of the invention disclosed is when two organizations merge or join. Regardless of timing, the merging of two organizations is an unavoidably complicated proposition requiring a huge amount of time, energy, and capital for sorting out which assets are additive, which are conflicting, and which are redundant. The present invention includes a means to benefit the new organization from its newly expanded relationship network from the start. Automated discovery and cataloging of relationship information, such as that found in email headers, makes integrating an acquired company's relationship information a streamlined process, rather than a burden and lost opportunity.

The present invention includes the advantage of using any information that is related to relationship management within an organization, such as but not limited to information or data stored in customer relationship management databases, sales force automation systems and databases, contact information databases, phone records, and instant messaging contact or buddy lists (similar to those provided by various internet service providers) in addition to information contained in e-mail headers. These sources of information can be “mined” to obtain the necessary information needed to create an effective relationship management system in accordance with the teaching of the present invention.

These and other objects and advantages of the present invention will appear more clearly from the following description in which the preferred embodiments of the invention have been described in conjunction with the drawing figures.

### BRIEF DESCRIPTION OF THE DRAWINGS

The present invention is illustrated by way of example, not limitation, in the figures of the accompanying drawings, in which like references indicate-similar elements and wherein:

FIG. 1 represents the architecture for capturing and mapping of data related to relationships, for example in the form of email interactions;

FIG. 2 is an example of how a user can search for a connection to a target individual based on knowing certain attributes of the target individual;

FIG. 3 depicts an example of how search results for relationships between individuals within the organization and target individuals can be displayed anonymously and how search results can be displayed in order of relevance ranked by a scoring system, or by taking into account some user selected attributes;

FIG. 3a depicts an example of how search results for relationships between individuals within the organization and target companies can be displayed anonymously and how search results can be displayed in order of relevance ranked by a scoring system, or by taking into account some user selected attributes;

FIG. 4 depicts an example of how a requestor can request an introduction to a target individual by customizing a message, which may or may not be kept anonymous, to be sent to an individual with a relationship with the target individual;

FIG. 4a depicts an example of how a requestor can request an introduction to a target company by customizing a message, which may or may not be kept anonymous, to be sent to an individual with a relationship to the target company;

FIG. 5 depicts an example of an individual's homepage which may display a summary of current and completed requests made by the individual viewing the homepage as well as those requesting an introduction from the individual viewing the homepage;

FIG. 5a depicts an example of the system tracking the outstanding requests for introduction to various Target Persons;

FIG. 5b illustrates the requestor's electronic mail in-box after sending out a request and receiving a system generated confirmation that a request was routed;

FIG. 5c depicts and example of the system tracking the outstanding requests for introduction to various Target Companies or Organizations;

FIG. 6 depicts an example of a request received by an individual that has a relationship with the target individual and includes an example of how an incentive is tracked and presented to the individual in accordance with the teachings of the present invention;

FIG. 6a depicts an example of a request received by an individual that has a relationship with the target company and includes an example of how an incentive is tracked and presented to the individual in accordance with the teachings of the present invention;

FIG. 6b illustrates the Link's electronic mail in-box after the requestor sends out a request and the Link receives a system generated message that a request is waiting for the Link to act on;

FIG. 7 depicts an example of a user receiving a reply to his or her introduction request to a target individual and includes capabilities such as accepting the request, continuing the dialog, or requesting more information—all of which may or may not be kept anonymous;

FIG. 7a depicts an example of a user receiving a reply to his or her introduction request to a target company and includes capabilities such as accepting the request, continuing the dialog, or requesting more information—all of which may or may not be kept anonymous;

FIG. 8 is a flowchart depicting how the data may be gathered from the header of emails to build the relational database;

FIG. 9 is a flow chart depicting how the request may be handled;

FIG. 10 is a relational table for the email-header information gathered;

FIG. 11 is a relational table for the profiles gathered;

FIG. 12 is a relational table containing the fields used in building the relational data;

FIG. 13 shows a system for querying a company's server or servers in order to retrieve or pull data that includes relationship content information; and

FIGS. 14a and 14b is a flow chart depicting the process of establishing a connection between a data center and a company server in order to download or pull the data that includes the relationship content information from the company server to the data center.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention.

In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

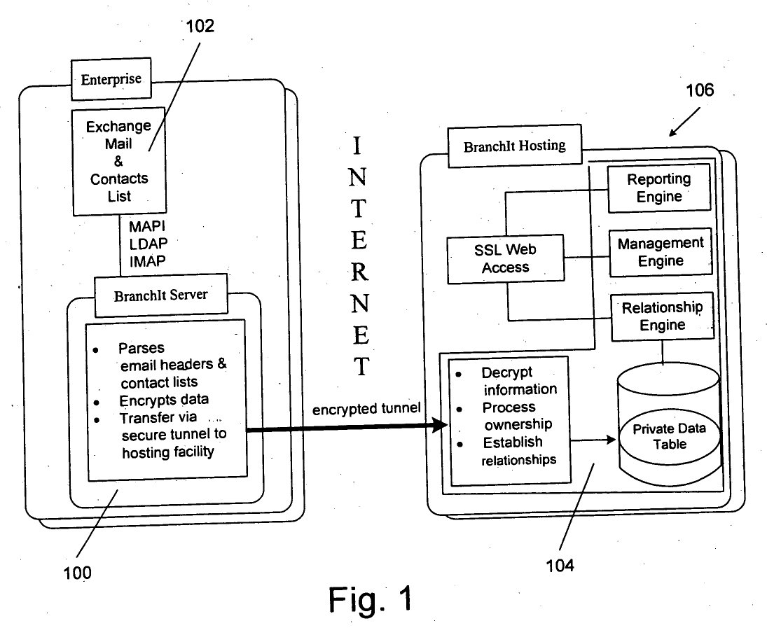

Referring to FIG. 1, a system 100 is operatively coupled to a company's or an organization's email server 102. Alternatively, a client can be operatively coupled to each user's local email account. In either case, the system 100 is used to view and catalog data or information found in the emails including the requestor's name, email address, and date of interaction with the target individual, as well as other information that may be relevant to gathering the data needed to assess the strength of the relationship between a particular member of the organization and the target individual that the requestor desires to meet. For simplicity, the data that is gathered is referred to herein as relationship information or relationship data and the terms are used interchangeably.

Although the foregoing embodiment relates to assessing the strength of relationships between individuals within an organization and target individuals outside the organization (or target individuals within the organization as detailed below), alternative embodiments are possible within the scope of the present invention. For example, one alternative embodiment of the present invention relates to assessing the strength of relationships between individuals within the organization and target organizations, including various departments within the target organization and various job titles or positions within the target organization.

In accordance with the present invention, in the event that the user of the system requires help in using the various features of the system, the user can activate a help menu. The help feature is launched and initially starts with an audio/video tutorial of the associated page the user is currently residing on so the user can quickly get up to speed on the functionality or features associated with that given page. Once the user has gained the necessary assistance, then the user can proceed to access the functions or feature of the system 100 presented to the user.

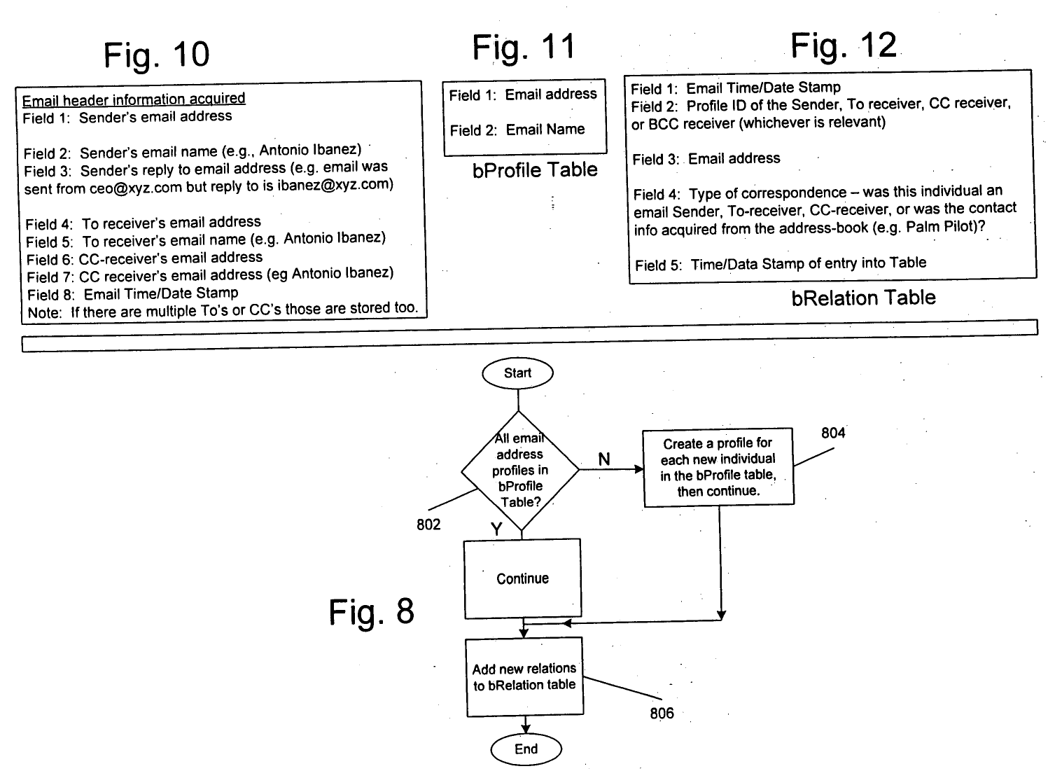

In one exemplary arrangement, the system 100 accesses the organization's server 102 and catalogs the information contained in the headers of all the emails sent and received through the organizations servers, as set forth in FIG. 8. The data acquired from the email is stored in a table as shown in FIG. 10. As indicated in FIG. 8, if the system 100 detects that the profile is not part of the profile table, step 802, then the profile is added to the bProfile table of FIG. 11 at step 804 of FIG. 8. The process then proceeds to step 806 of FIG. 8, wherein the new relation is added to Relation table of FIG. 12, as indicated below. The system 100 is designed to read the email-header information and ignore the email message content in order to make the process of extracting the relevant data more efficient. However, it is within the scope of the present invention to design the system 100 to be able to read and analyze the content of the email message along with its attachments, if any. Additionally, as discussed in detail below, the system 100 will be able to pull the information from the server 102 automatically so that the information is maintained at a remote data unit or bank 104.

The system 100 catalogs and tabulates information relating to who is sending emails to whom, when emails have been sent, and who is replying to them. Based on the format of the names and domain names in the “send to”, “cc”, and “bcc” sections of the header (e.g., Lastname, Firstname nameformat@entity.com), the organization's server 102 knows to whom the email was sent and for which company he or she works. Once the system 100 has analyzed the emails, calculations can be made and displayed relating to the link-strength between the individual within the organization and an individual outside the organization.

In the preferred embodiment, the information gathered by the system 100 is encrypted, using standard encryption technology, and sent over the Internet through a secure channel/tunnel to a hosting facility 106 where a remote unit 104 is located. At the hosting facility the information is decrypted and relationships are determined and established based on the parameters that were analyzed. Such relationships are then stored in a private data table for future access, such as the tables shown in FIGS. 10, 11, and 12. The data is then decrypted and the remote unit 104 analyzes parameters, such as how often a member of the organization emails Individual A at Company X, how often Individual A replies back, the amount of time lapsed since the most recent email interchange, whether there have been attachments or not, and so on.

By analyzing the member's email address books, the system 100 in conjunction with the remote unit 104 can provide both a quantitative and a qualitative measure of the strength of the relationship between the member and a target individual, such as Individual A. For example, having a work or office number represents a certain level of familiarity, while having a home and/or cell phone numbers in the address book implies a much stronger connection.

In accordance with the present invention, a requester queries the system to determine if there is anyone, referred to as an individual or a familiar contact, with a connection to the target individual. The system identifies these familiar contacts and provides evaluation tools to the requestor that are based on relationship-analytics, which are displayed to the requestor. For example, the system performs an analysis of the responses and/or the responsiveness of each familiar contact or person in order to provide calculated performance data and ratings for each familiar contact identified as having a connection to the target, without revealing the identity of the familiar contact. For example, the rating can be numerical, such as a ratio of 7-5-3, which indicates the responsiveness of the familiar contact. Thus, in the present example, if there are four identified familiar contacts and familiar-contact-1 has a 7-5-3 ratio, it would infer that familiar-contact-1 received 7 requests, responded to 5 of them, and made 3 introductions. Yet another evaluation parameter for the requestor may be the response time of each familiar contact. Thus, if familiar-contact-2 has a median-response-time of 3 days, the requestor would know approximately how long to expect to wait for a response when reaching out to this familiar contact. In this way the requestor can determine which of the identified familiar contacts is most likely to be responsive and based on that the requestor can select from the identified familiar contacts which familiar contact best suits the requestor's needs.

Other examples of information that can be used to determine the strength of a relationship include an analysis of meetings scheduled within electronic calendars such as physical meetings between individuals involved in email exchanges, scheduled phone calls, and so forth. The system could also take into consideration such data sources as phone records, and the content of Personal Digital Assistants (PDA's), including the calendars.

In an alternative embodiment, the remote unit 104 can be a local unit that is located at the customer premises proximal to the system 100 and the server 102, so that the information that is gathered does not need to be transmitted through the Internet in encrypted format to a central storage facility.

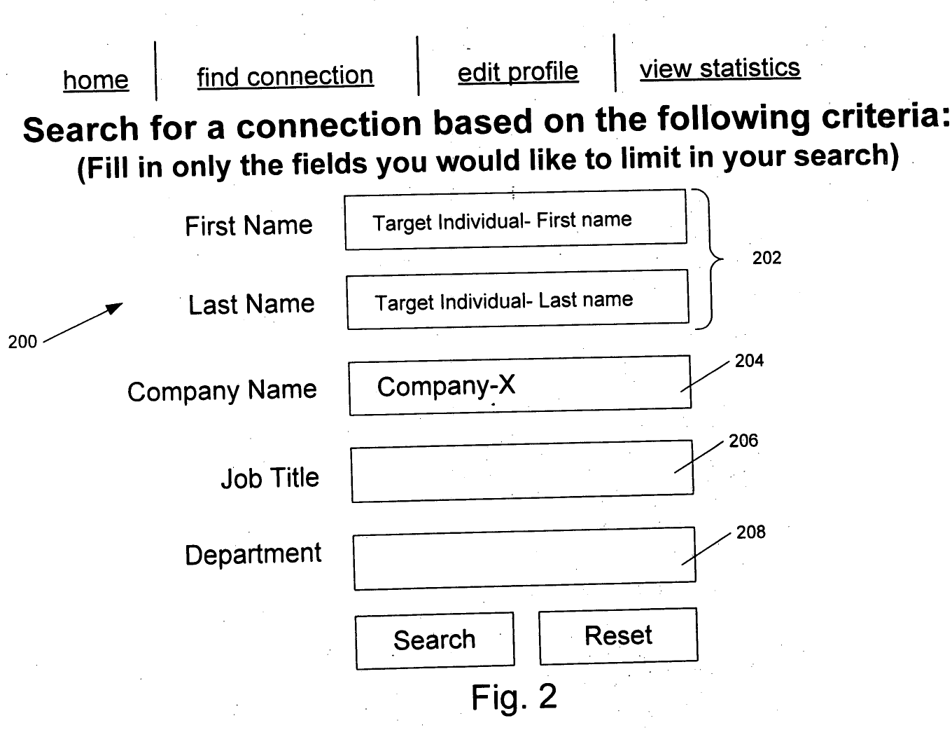

Referring now to FIG. 2, once the relationships have been determined and established, the requester can open a request by entering the relevant information into any one or more of the fields 202, 204, 206, and 208 of the user interface window 200. Information entered into one or more of the fields is sent to the system where the data is stored. Sample fields include a search for a connection to a target individual based on knowing certain attributes of the target individual including but not limited to First Name, Last Name, Company Name, Job Title, and Department. The process is demonstrated through the example that follows.

Employee at Company O wants to get in touch with Target Individual at Target Company for a business proposal. Employee doesn't have a relationship with Target Individual, nor does he have any contact information. Further, Employee doesn't know anyone who knows Target Individual. Rather than trying to cold-call Target Individual, Employee logs-on through his or her employer's intranet; alternatively the employee can log-on externally through a Virtual Private Network or VPN or at any web-browser, to utilize the system 100 working with the remote unit 104 to determine if anyone at Company O has an existing relationship with Target Individual.

Employee logs on to the system 100, either through his or her intranet connection or through the internet using the company's secure connection, and goes to the “Find Connections” section, such as shown in screen 200 of FIG. 2. Employee enters Target Individual's name and company into the fields 202 and 204, respectively, of screen 200. If Employee didn't know that he was looking for Target Individual in particular and just wanted someone from Target Company from a specific department, he could enter that information instead in the relevant fields. Once Employee submits the information it is sent to the remote unit 104 of FIG. 1 to search for relationship owners or Links at Company O that have a relationship with Target Individual as detailed below.

Reference is made herein to various “Links” with the understanding that the phrase “Link” is an anonymous representation of an individual. In alternative embodiment, such as a system contemplated by this invention wherein anonymity is not preserved, the name of the individual could be used instead of the word “Link”.

In an alternative embodiment, the Employee could access the system via any type of device that allows remote access to the system, such as a PDA. In this case the Employee would log-on to the system from a remote device and after authentication of the Employee as an authorized user, the user would have access to the system to make requests or respond to received requests.

Furthermore, the system 100 of FIG. 1 can monitor the users currently logged on to the system 100 and, thus, be able to provide the requestor with relevant information about each potential “Link” that may be immediately available to provide an immediate response. The system 100 could monitor certain parameters, such as idle time or other criteria to provide accurate information to the requestor relating to the immediate availability of the “Link” to provide an immediate response to the requester.

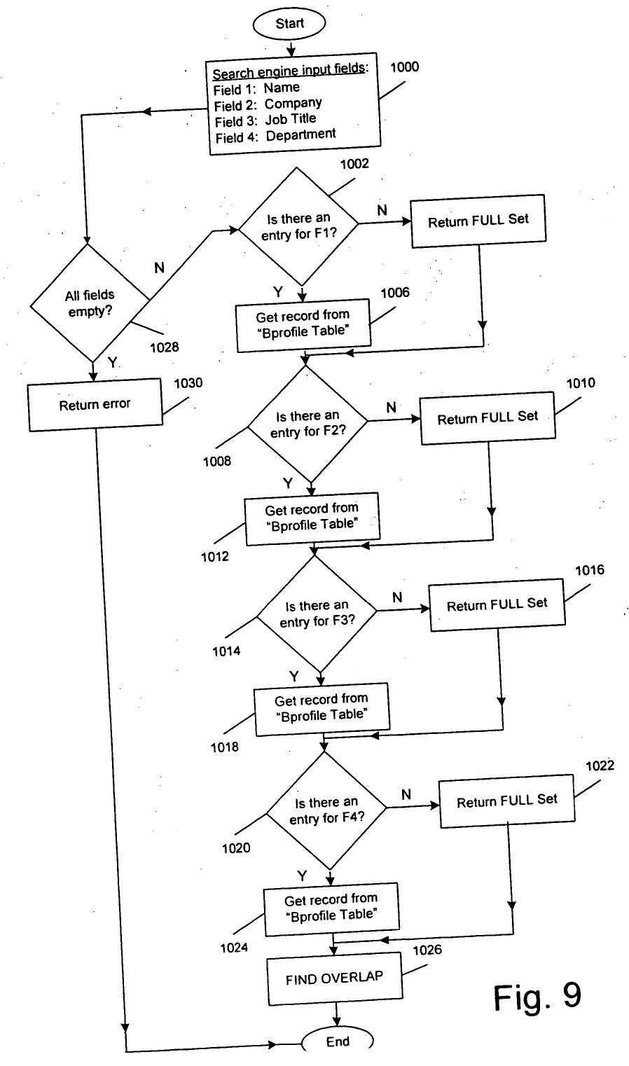

Referring now to FIG. 9, at step 1000 the system receives the request. At steps 1002, 1008, 1014, and 1020, the system looks at the request to determine what information, if any has been entered. If no information is entered in any of the fields, then the system detects that all fields are empty, step 1028, and returns an error message to the requester, step 1030.

If information is entered in at least one field, then the system begins evaluating the content of each of the fields. For the fields that contain information, the system searches the relevant tables, such as the bRelation table, shown as bRelation table in FIG. 12, to find a corresponding data element and returns that value. If there is no information entered in the field being analyzed, then the system returns the entire range of values that corresponds to the range of possible values for that field. Once all of the fields have been evaluated, the system, at step 1026, finds the overlap of the returned values based on the information entered in the fields. Although only four fields are shown and discussed, it is within the scope of the invention to use any number of fields, depending on customer needs, such as more or less than four fields.

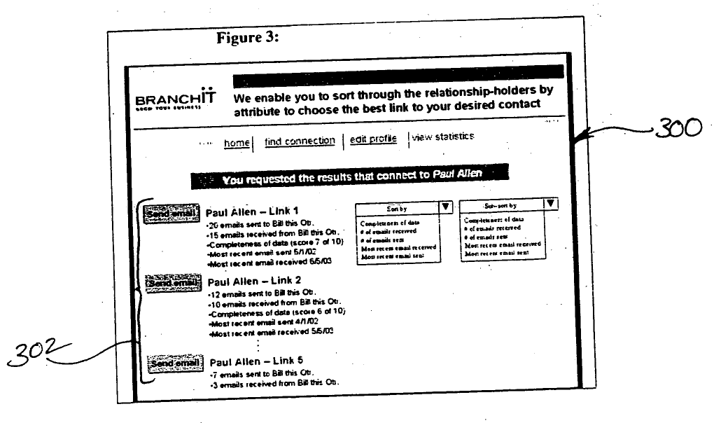

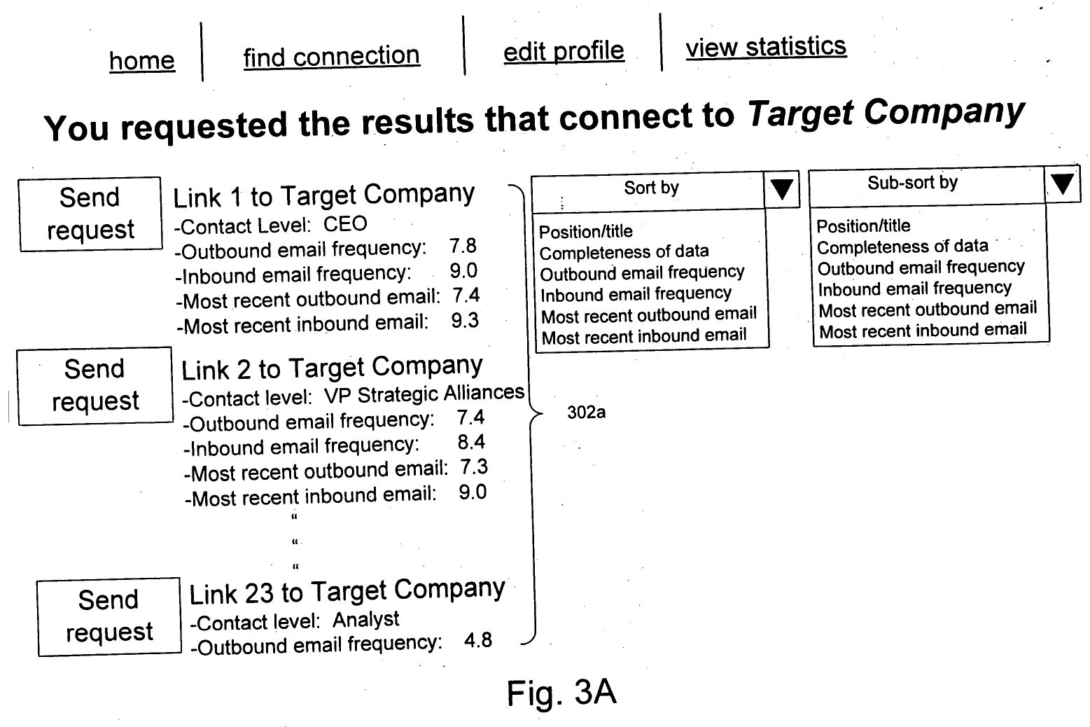

Referring now to FIG. 3, with the data in the fields 202, 204, 206, and 208 of the request evaluated, the system can then return a user interface screen 300. The user interface screen 300 in the preferred embodiment is a browser type interface, having a select number of links 302. The results are presented as links so that the identity of the person is anonymous, shown in FIG. 3 by the words “Link 1,” “Link 2,” and so on in order of link strength.

In the specific example, the number of “Links” is shown to be limited to five. However, the remote unit 104 can return to the Employee any number of links, including all of the people within Company O that have any relation to the Target Individual. The number of links returned can be either set by the requester or established by the system administrator.

FIG. 3 depicts an example of how search results can be displayed anonymously. It displays the name of the target individual, in this case Target Individual, but it may disguise or not display altogether other information including but not limited to contact information on the target individual as well as the name and contact information of the individual with a relationship with the target individual (shown in this example by listing “Link 1”, “Link 2”, . . . , “Link 5” instead of revealing the individual with a relationship with the target individual).

FIG. 3 also depicts an example of how search results can be displayed in order of relevance, ranked by a scoring system that may take into account some of the following or other attributes including but not limited to the frequency of interaction, recentness of the interaction, and the completeness of contact information held by the individual with a relationship to the target individual. The requestor may also be given the option to re-sort the. search results based on one or more attributes that he deems most important. The system may then re-weight the scoring system accordingly for the displaying of future search results by retaining information about how the requestor prefers to have the information displayed.

In accordance with the present invention, link strength is estimated based on a weighting system that analyzes for example, frequency and recentness of the interaction, address book completeness, and so on. However, if Employee wanted to, he or she could modify the ordering of results to favor, say, recentness of the interaction as the most important aspect, in that he would like to see which link has communicated with Target Individual most recently. Or perhaps Employee would like to link through the contact that he or she deems has the closest “personal tie” to Target Individual. Then, Employee would favor those links with a high score for “address book completeness.” In this example, Employee chooses to connect with the link suggested by the system 100 as determined by the remote unit 104, selecting the first option, “Link 1,” as his intermediary.

FIG. 3 also depicts an example of how search results can include the ability to connect with an individual with the relationship to the target individual, such as placing a button labeled “Send request” next to each of the search results.

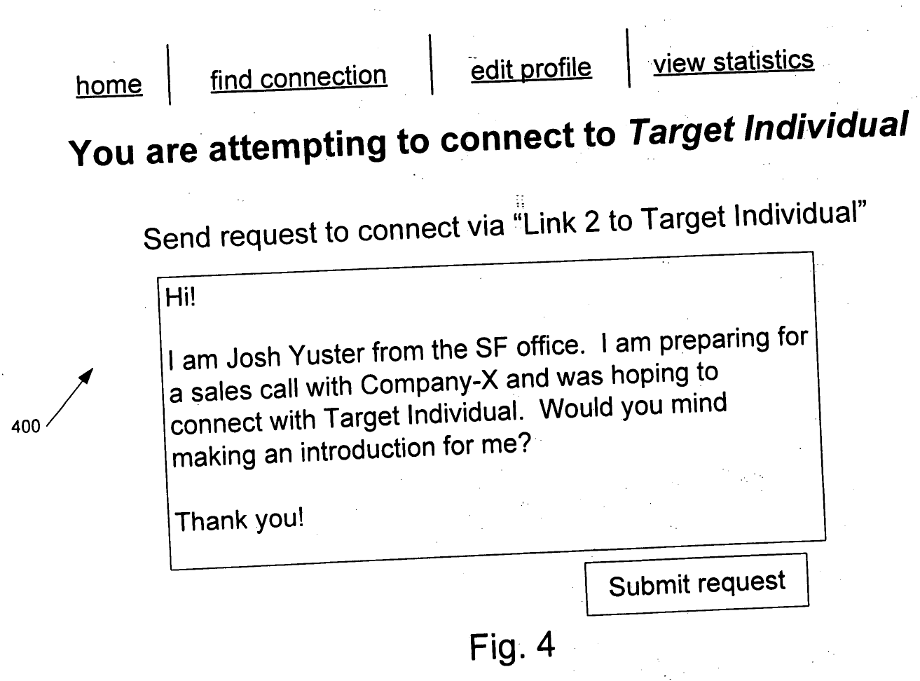

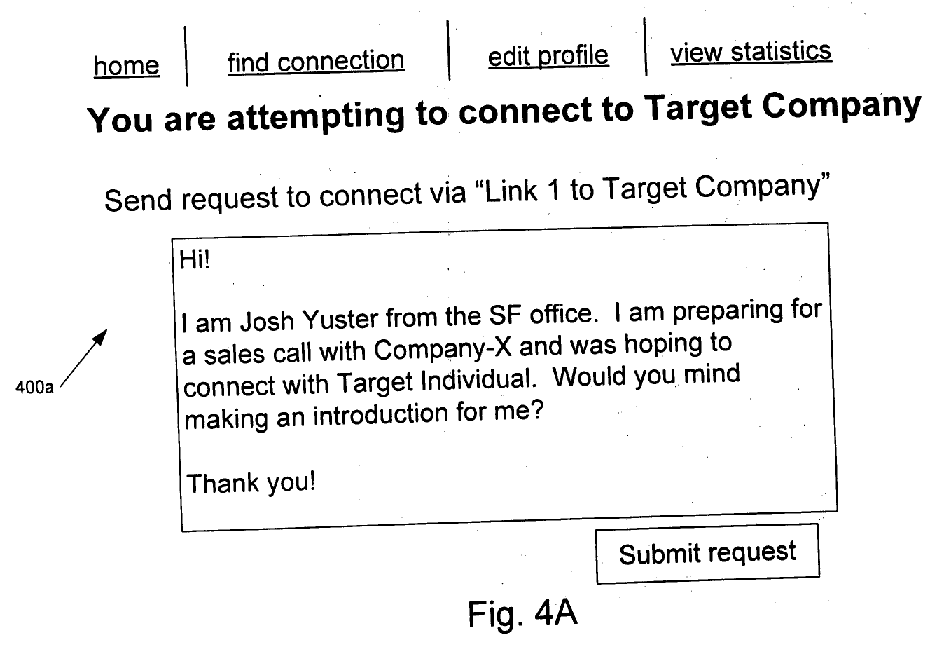

FIG. 4 depicts an example of how one can request an introduction to a target individual by customizing a message, which may or may not maintain anonymity, to be sent to an individual with a relationship with the target individual. Once Employee selects “Link 1” as his choice, he is brought to an introduction request page 400. In it, Employee enters his request to the anonymous “Link 1,” which might read, “Hi there, this is Employee over in management. I'm trying to get in contact with Target Individual at Target Company to talk about a company I'm thinking about buying . . . . ”

If Employee decides to remain anonymous, then Employee would clearly not include his name. Thus, Employee would send a message without revealing his identity since the system can keep Employee's identity anonymous. In that scenario, the request might read “Hi there, I'm trying to get into contact with Target Individual at Target Company to talk about a company I'd like to buy. Could you facilitate contact between us?” The email message then gets sent through the system 100, which knows the identity of both the Employee and the “Link” (or the intermediary) and is capable of properly routing the message without revealing the identity of either or both. At this point, Employee still has no information about the identity of “Link1”.

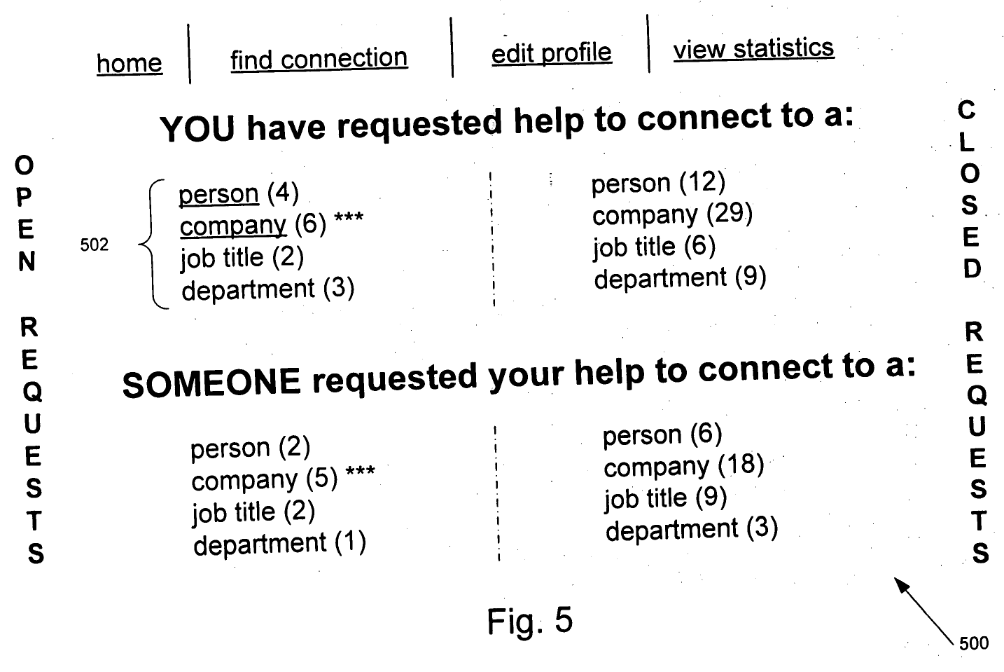

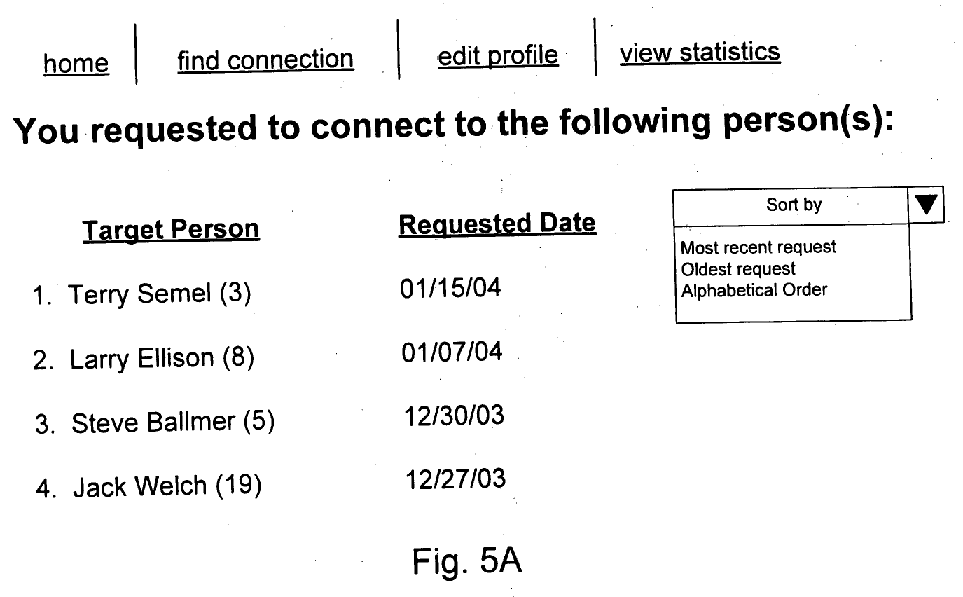

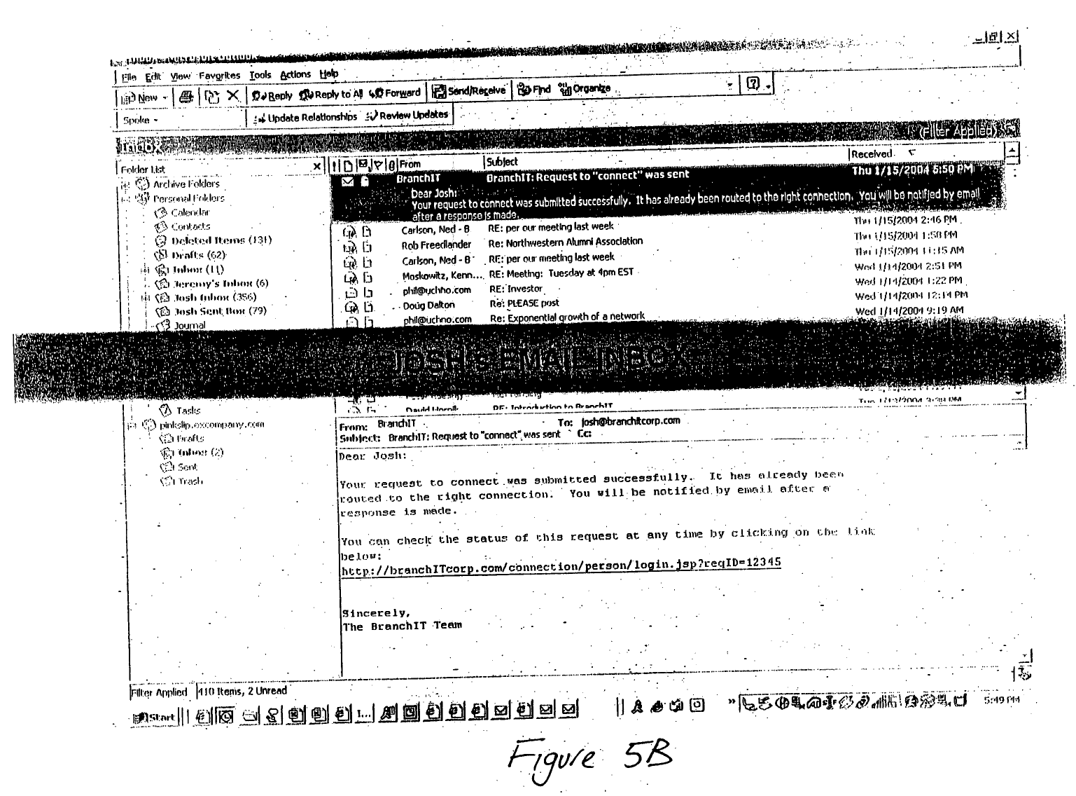

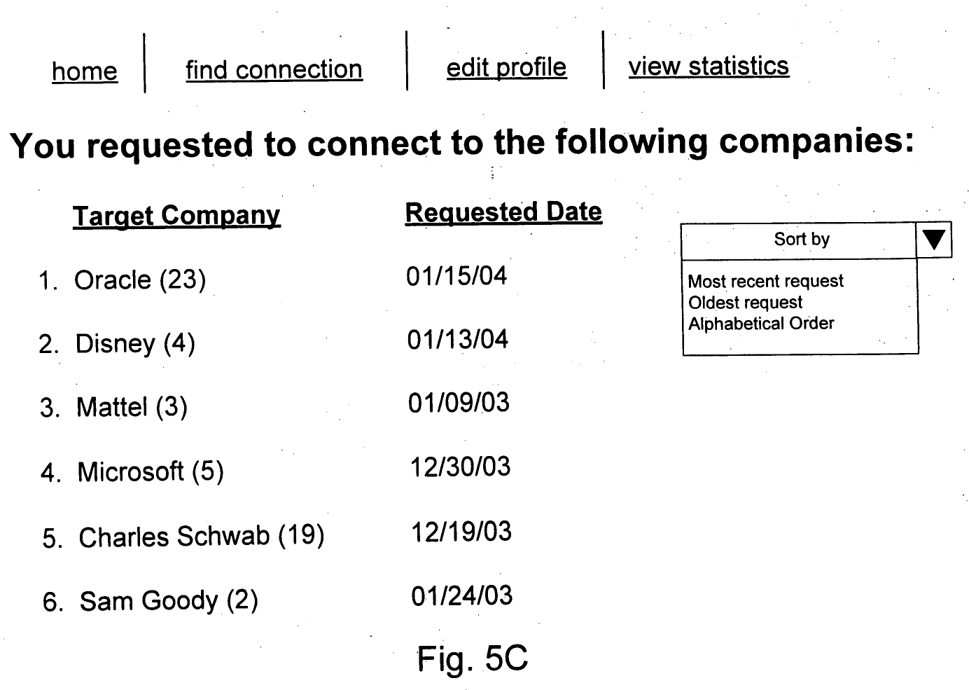

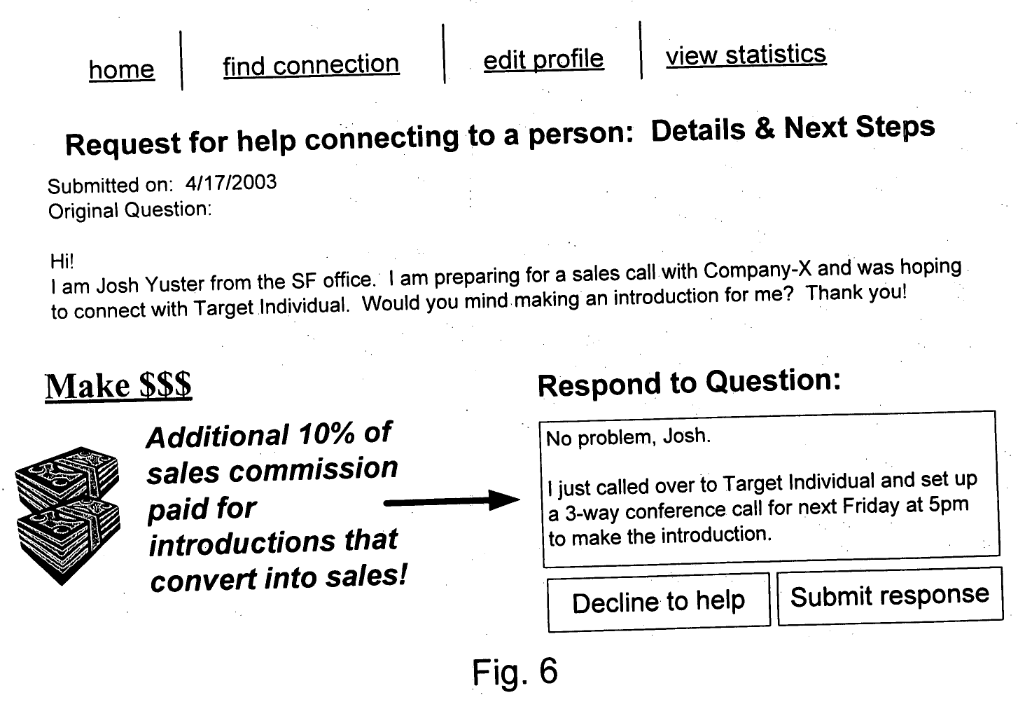

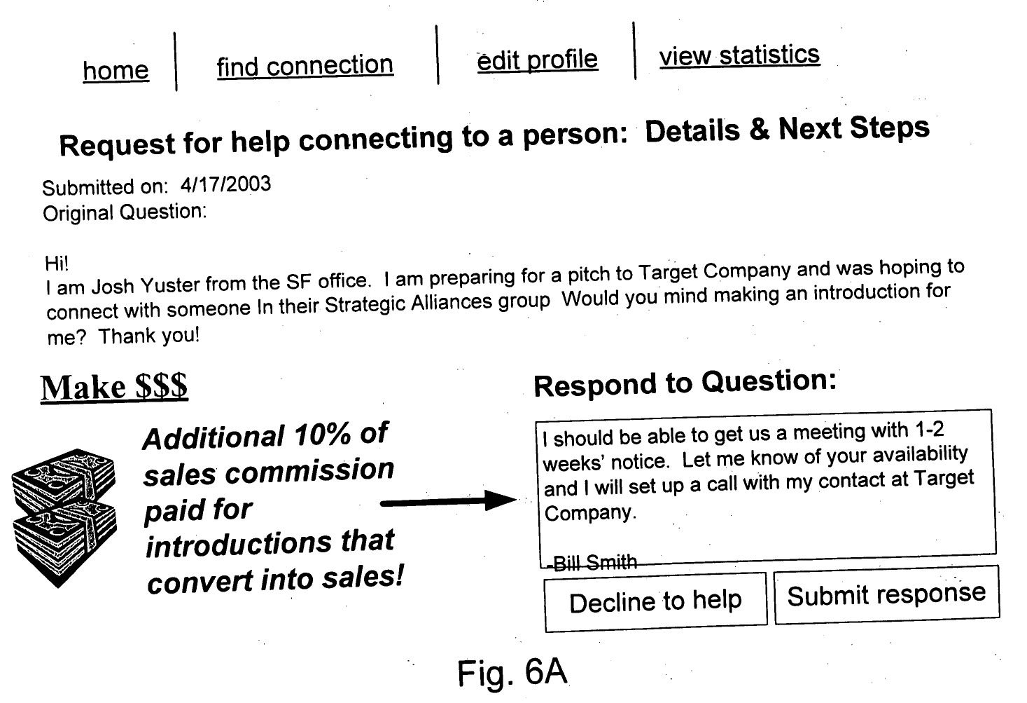

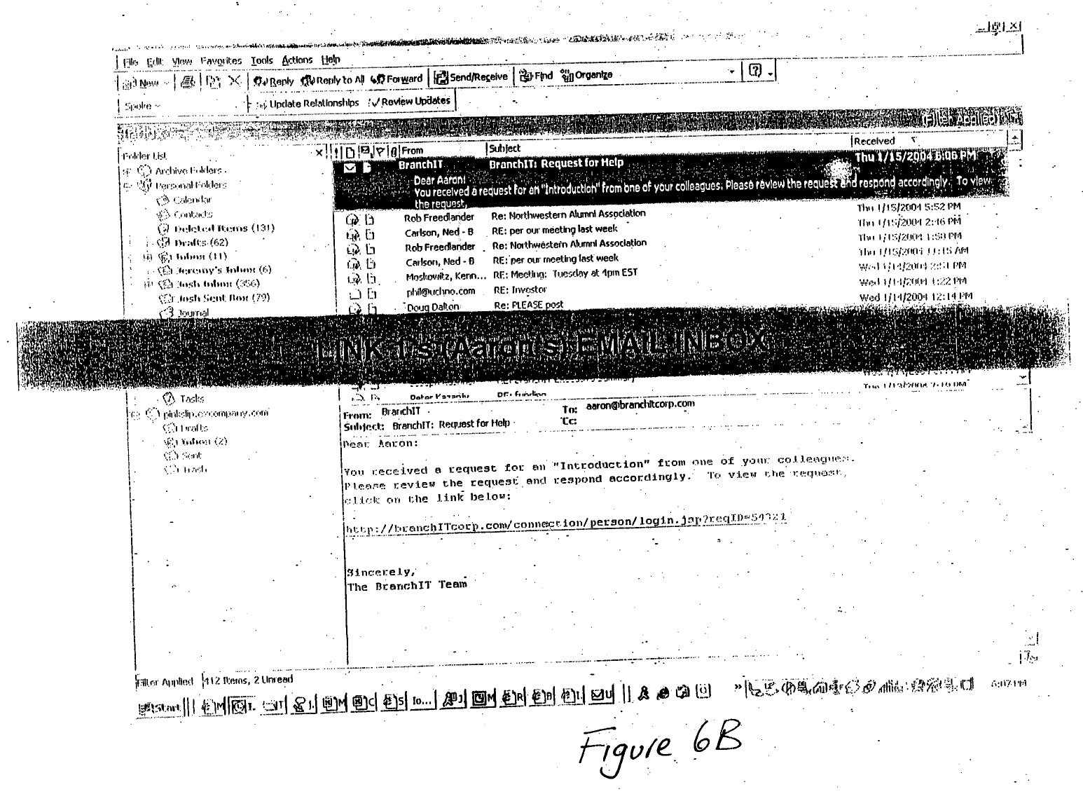

Referring now to FIGS. 5 and 6, after the request has been made, Employee is returned to a homepage, where it shows the number of requests that are outstanding at location 502. On the other side of the request or transaction, once Employee files his request with the system 100, the system 100 sends the request to the anonymous “Link 1.” The request lands in “Link 1's” email inbox, and “Link 1” can open and read the request. The email can be set up to contain a link to the request page in Link 1's account, and clicking on it takes him or her to that page as shown in FIG. 6.

FIG. 6 depicts an example of a request received by an individual that has a relationship with the target individual. It can display or tie into an existing incentive, or enable the two individuals to negotiate a one-time incentive. It also may provide other capabilities including accepting the request, declining the request, beginning a dialog, or requesting more information13 all of which may or may not be done anonymously.

Then, Link 1 can either decide to make the introduction requested by the anonymous requestor, decline the request, or ask for more information and start a dialog with the requester. If Link 1 declines the request, then Link 1's identity will stay hidden from the requester, if the system is configured accordingly. Keeping Link 1's identity hidden prevents internal office politics from becoming inflamed as a result of the decision not to make the introduction.

However, if Link 1 should decide to make the introduction, Link 1 can respond to the requestor, who may or may not be anonymous, informing him or her of the plan to do so. This is clearly a streamlined version of the actual process.

It is clearly contemplated that certain situations will arise where an interchange is likely to involve more than a few rounds of replies before “Link 1” would agree to make an introduction. Thus, the system 100 along with the remote unit 104 are platforms that enable the requestor to anonymously connect with a Link that has a relationship with the target individual.

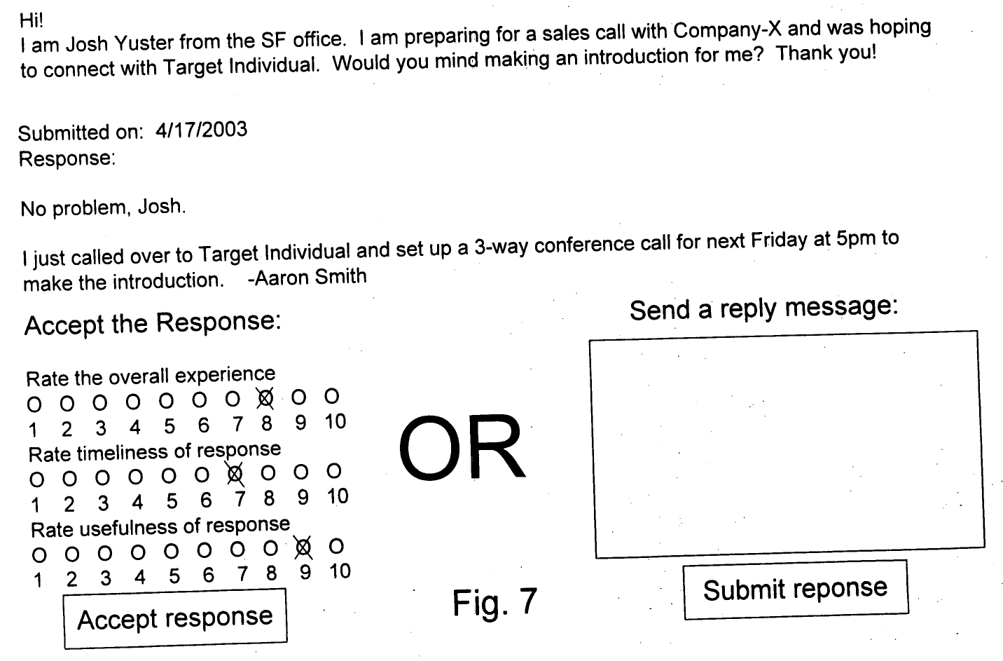

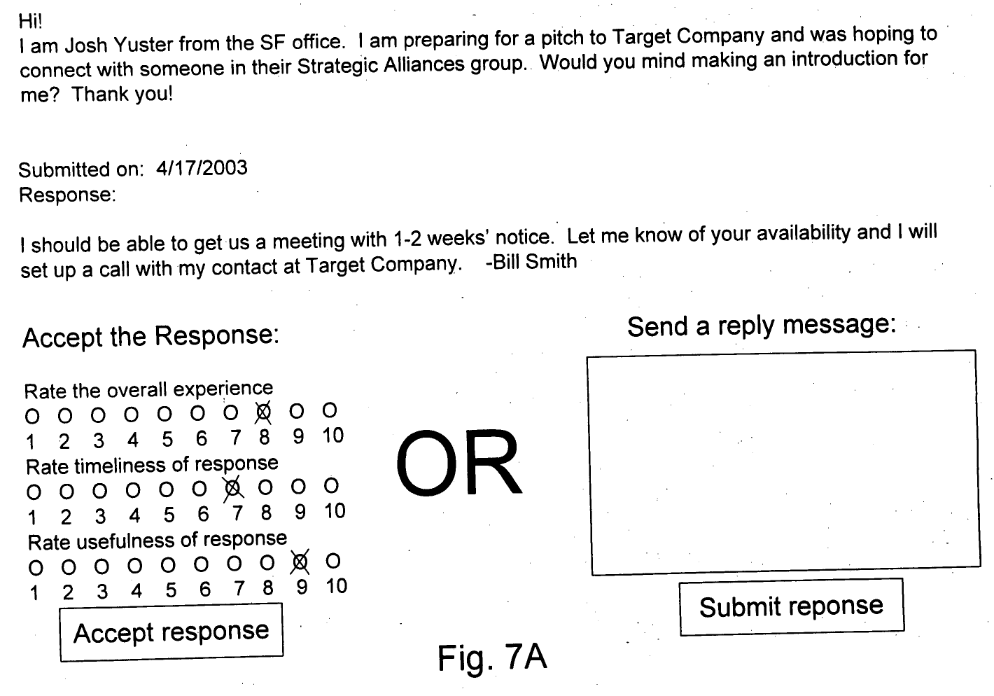

Referring now to FIG. 7, which is an example of Link 1's response to the requester, the system 100 alerts the requestor that someone has replied to a request, and to follow the link into his account. He clicks on the open request to find that Link 1 has replied. The choices include accepting the request, continuing the dialog, or requesting more information—all of which may or may not be kept anonymous. In addition, it may display a set of questions used for tracking usage metrics among other things, which may or may not be customizable by the administrator.

At any point, either party can close the request, and the system moves the request from the “Open Requests” section to the “Closed Requests” section as shown in FIG. 5. Once the request is closed, the system can ask the requestor to rate the performance of Link 1. Future requestors can use such ratings to evaluate the reliability and effectiveness of Link 1 in making introductions. In a similar manner, Link 1 can be asked to rate the performance of the requestor as it relates to how the target individual perceived the requester or how the requestor handled responding to the questions and directions from Link 1. Any number of other relevant criteria can be established to rate and evaluate the requestor and Link 1 at the end of a request, regardless of whether Link 1 accepted or rejected making the introduction.

Accordingly, the system 100 along with the remote unit 104 includes the ability to monitor actions taken with respect to new relationships that have been established as well as existing relationships. Once a relationship has been established, the requestor can set-up certain parameters that assists the requestor in maintaining the relationship for future requirements. For example, the requestor can define certain conditions, such as the time lapsed since the last email correspondence, which the system can monitor. If the conditions defined are not satisfied or certain limits are exceeded, then the system alerts the requestor that the requestor-defined parameters are exceeded or not satisfied. Thus, through a series of alerts, the system notifies the relationship-holder to take action, such as advising the requestor to reconnect with the target individual in order to maintain and strengthen the relationship. Although the foregoing system and method are described in terms of actions taken by the requester, any individual with access to the services contemplated by the present invention can establish criteria that can be monitored in order to receive alerts, which are in response to the criteria defined. This is done to assist the individual to maintain or enhance any relationship. Consequently, the present invention can assist users in strengthening their weaker relationships with well-timed system generated alerts in the form of emails containing data relating to the parameters established by the user as to why the alert was triggered.

The present invention is described in terms of tracking a relationship between a person within an organization and a person outside the organization. However, it is within the scope of the present invention to track and provide information about relationships of individuals within the organization and the strength of those relationships. Thus, a person within an organization may wish to be introduced to another person within the organization and, thus, request such an introduction from other members of the organization familiar with that person. Alternatively, the strength of the relationship between two individuals of an organization can be tracked, such as the relationship between the requester and the “Link”, and presented to the requestor and/or the “Link” by the system. Using this relationship strength, the requester has another parameter to consider in determining which Link to be selected from the group of anonymous Links has the best relationship with the requestor. Similarly, the Link receiving the request can be provided relationship information, which relates to the relationship between the Link and the requestor, as another criterion to consider in deciding whether or not to make the introduction.

The present invention also tracks information relating to the frequency or acceptance rate of any individual attempting to make an introduction relative to the number of requests that the individual has received. Accordingly, the requestor can be presented with data relating to the Link's ranking or rate for accepting requests to make introductions. The criteria presented to the requestor can even be specific enough to show the acceptance rate or ranking of any Link relating to requests to make introductions to a specific individual outside the organization. Thus, the requestor can see the acceptance ranking of any individual with respect to all requests as well as with respect to the specific request for a particular individual outside of the organization. As indicated above, the similar ranking information can be presented regarding requests for making introductions to individuals within the organization.

In addition to presenting data relating to the strength of relationships between individuals, the present invention tracks Link information relating to company incentives and provides such information to those being asked to make an introduction. For example, if there is an incentive for making an introduction, then that particular incentive is presented to the individual or “Link” along with the request from the requestor. Thus, the individual receiving the request is immediately made aware of an incentive for participating in and making the introduction. This incentive information, along with the data relating to the individuals that participate in the incentive, is compiled by the system for later presentation to the appropriate department within the organization that requires the information to ensure that the individual receives the incentive promised.

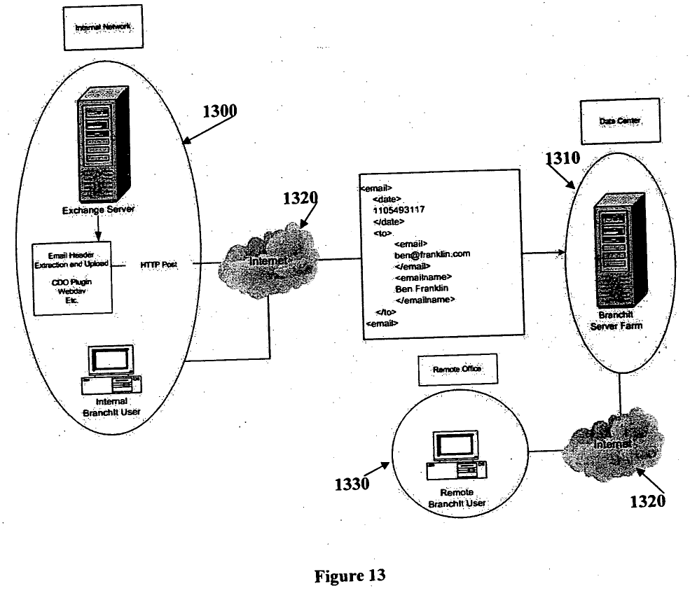

Referring now to FIG. 13, a company system 1300 is in communication with a data center 1310, such that during a communication session the data center 1310 can retrieve relationship information from the server or servers located at the company system 1300. It will be apparent to those skilled in the art that the function of the server can be performed by a single computer or by a group of computers. The company system 1300 includes a server or a group of servers and may or may not include internal users or user terminals. The users are grouped into user groups and the number of user groups depends on system design as well as how many users each server can support. Thus, there may be just one user group supported by a single server or there may be several user groups each supported by a server. In alternative embodiments, a user may have more than one user profile and, hence, more than one email address. Accordingly, the user may have a profile on more than one server. Furthermore, in another embodiment, there may be multiple servers whose users get associated together remotely by the data center 1310. Thus, the scope of the present invention includes the situation where two user identities for the same user are supported by or located on two servers or one user identity is supported by two servers.

In accordance with one aspect of the present invention, the program or software necessary for extracting relationship information from the company system 1300 is loaded at the data center 1310 thereby eliminating the need to load software into the servers or the user terminals of the company system 1300.

In accordance with the teaching of the present invention, the data center 1310 can communicate with and retrieve or pull relationship information or data from the company system 1300 without having to update each individual user's terminal. Even though the company system 1300 is shown with only one server and one user, the company system 1300 includes any number of servers, each supporting a group of users. For example, there may be three servers supporting three user groups. Alternatively, there may be just one server supporting one user group. The company system 1300 and the data center 1310 are in communication through the Internet 1320. Additionally, a remote office or remote user 1330 also communicates with the data center 1310 through the Internet 1320. The scope of the present invention includes any number of user groups supported by any number of servers as well as any number of remote users.

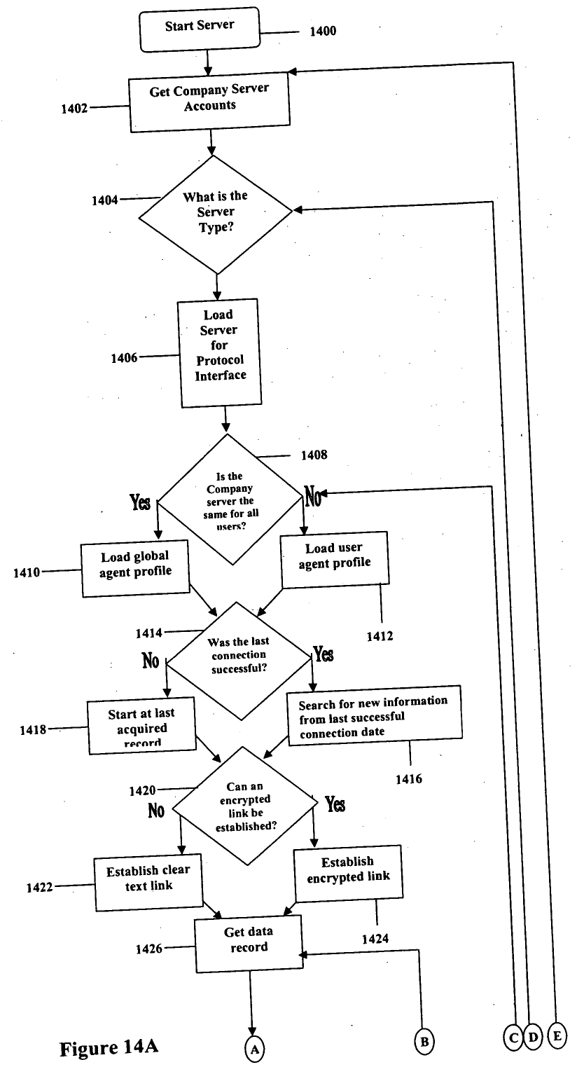

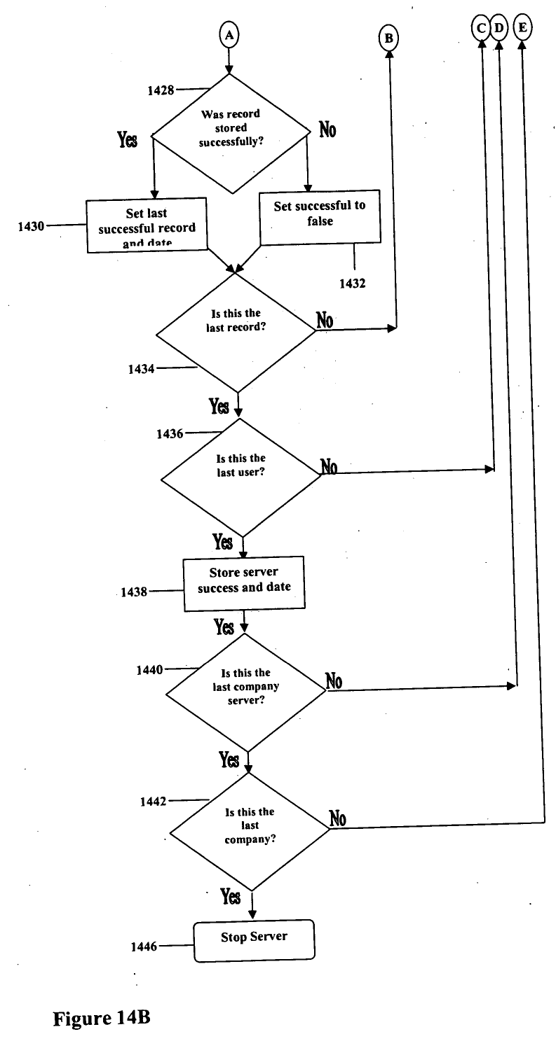

Referring now to FIGS. 13 and 14, the process of downloading or pulling data or relationship information from a company side server at predetermined time intervals begins at step 1400 wherein the server of the data center 1310 initiates communication with the server of the company system 1300. At step 1402 the data center 1310 accesses its database or memory that contains information about the various company systems, such as the company system 1300. The data center 1310 retrieves this data or information for each company system scheduled to be queried in order to update and pull the relevant data, which can include non-relationship data as well as relationship data. At step 1404 the data center 1310 determines the type of server that is at the company from which the data will be pulled. For example, the server can be any one of the following: IMAP, Exchange, Lotus Notes, Customer Relationship Management (CRM), ERP, Applicant Tracking System (ATS), or a PBX interface. However, the scope of the present invention is not limited by the type of server that is present at the company system 1300. At the step 1406, the data center 1310 retrieves the appropriate module that includes the appropriate protocol corresponding to the protocol for communication between the data center 1310 and that type of server, which is part of the company system 1300.

At 1408 the data center 1310 determines if there is one server at the company system 1300 that serves all users and/or communication sessions or if there are several user groups each supported by a different server. For example, the user machine requesting information may belong to one user group that is serviced by one server at the company system 1300 while a second user may belong to a second user group that is serviced by a second server at the company system 1300. If there is only one server at the company system 1300 or there is only one user group supported by one server that is being queried, which would be the same server supporting other users, then at step 1410 the data center loads the global agent profile. If the user is at a remote location or office or there are multiple user groups supported by different servers, then at step 1412 the data center loads the user agent profile specific to that user.

At step 1414, the data center 1310 determines if the last communication session was successful. If so, then at step 1416 the data center determines if there is new information since the last time information was pulled for that server at the company system. The new information is used to update the data for the company and the users. If the last communication was not successful, then at step 1418 the data center 1310 begins at the last successful communication session as determined by the time stamps associated with the server located at the company system 1300 and pulls the data since the last time stamp. In one embodiment, the time stamp data is stored at data center 1310. In an alternative embodiment the time stamp information is stored at the server located at the company system 1300. In yet another embodiment, the time stamp information is stored at the both the server located at the company system 1300 and at the data center 1310.

In the event the communication session is interrupted, then the data center 1310 also tracks which users have had their related data pulled and/or updated at the data center 1310. For example, if there are one hundred users in a user group and the communication session fails after the data has been pulled for the X^{th} user, such as the 35^{th} user, then the data center 1310 will be able to start the next communication session at the (X+1)^{th} user, such as the 36^{th} user. Accordingly, a failed communication session can be resumed at the point that the communication session failed.

Furthermore, in an alternative embodiment, large user groups can be split into smaller user groups. The task of handling updates for the smaller user groups is split among several servers at the data center 1310 resulting in quicker update time.

At step 1420 the data center 1310 determines if an encrypted link can be established between the data center 1310 and the server at the company system 1300. If an encrypted link can not be established, then at step 1422 a CLEARTEXT link is established and at step 1426 the data is pulled and stored as a data module at the data center 1310. If an encrypted link can be established, then at step 1424 the data center 1310 communicates with the server using an encrypted link and thereby pulls the data from the server at the company system 1300 using an encrypted link and at step 1426 the data pulled from the server is store at the data center 1310.

At step 1428 the data center 1310 determines if the data was pulled successfully from the server. If so, then the data center 1310 time stamps this last retrieval of data from the server. On the other hand, if the last communication session did not result in a successful retrieval or pull of the data, then at step 1432 the data center 1310 provides a time stamp and indicates that the last communication session was not successful.

At step 1434, the data center 1310 checks to determine if the information pulled was the last information for this user. If not, then the process returns to step 1426 to pull and save the next data associated with the user. If there are no other records or data to be retrieved, then the process continues to step 1436 to determine if this is the last user supported by the company system 1300. If not, then the process returns to step 1408 and the next user is selected. If at step 1436 the data center 1310 determines that this is the last user, then at step 1438 the data center stores the time and date of the last successful communication. At step 1440, the data center 1310 determines if there are any other servers at this company system that need to be accessed. If so, then the next server for this company system is selected and the process returns to step 1404. If at step 1440 it is determined that this server is the last server for this company system, then at step 1442 the data center 1310 determines if there are other company systems that need to be queried. If so, then the process returns to step 1402 wherein the next company account is loaded. If there are no other company accounts or systems to access, then the process ends at step 1446.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated.

What is claimed is:

1. A method for relationship-mining, the method comprising the steps of:
identifying a target;
determining the strength of a relationship between the target and an individual; and
providing a link to a requestor that identifies the relationship between the target and the individual while maintaining the identity of the individual anonymous.

2. The method of claim 1 further comprising the steps of:
keeping the identity of the requester anonymous; and
keeping information based on the relationship between the individual and the target anonymous until the individual authorizes the release of the information.

3. The method of claim 1 further comprising the step of providing the requester with evaluation information relating to the individual, wherein the evaluation information is used to determine the likelihood of the individual providing an introduction to the target.

4. The method of claim 1 further comprising the steps of:
querying a server supporting communication sessions for the requestor in order to gather data about the requestor's contacts;
querying a server supporting communication sessions for the individual in order to gather data about the individual's contacts; and
updating data associated with the requester and individual, wherein the data includes relationship information.

5. The method of claim 1 further comprising the steps of:
providing the identity of the requester to the individual upon the requestor's authorization; and
providing the identity of individual to the requestor upon the individual's authorization.

6. A method of providing data about a target to a requester, the method comprising the steps of:
evaluating the data to determine strength of relationships between other individuals and the target;
providing the requestor with a response identifying the existence of a relationship between the target and at least one other individual, wherein the identity of the individual is kept anonymous; and
allowing the requestor and the at least one other individual to communicate without revealing the identity of the individual.

7. The method of claim 6 further comprising the steps of:
providing the requestor with evaluation data about the individual, wherein the evaluation data is based on the individual's past performance; and
providing the requestor with timing data about the individual, wherein the timing data is based on the individual's past responsiveness and wherein the evaluation data includes at least two parameters related to the strength of the relationship between the individual and the target such that the requestor can evaluate the likelihood of the individual providing an introduction between the requestor and the target.

8. The method of claim 6 further comprising the step of providing an incentive to the individual when the individual assists the requestor in contacting the target, wherein the incentive is adapted to be displayed to the individual along with the request from the requestor and can be modified.

9. The method of claim 6 further comprising the steps of:
maintaining the identity of the requestor anonymous until the requester reveals the requestor's identity; and
revealing the identity of the individual upon authorization from the individual.

10. The method of claim 6 wherein the step of evaluating the data includes the steps of:
determining if the data generated by the individual about the target includes personal information about the target;
analyzing the correspondence between the individual and the target;
determining the timing of the data based on the latest contact between the individual and the target; and
determining the frequency of the contact between the individual and the target, wherein the personal information, the latest contact, and the frequency of the contact are parameters that are used to evaluate the strength of the relationship between the individual and the target.

11. A method for gathering data, the method comprising the steps of:
communicating with a company system in order to receive the data, wherein a data center initiates the communication;
determining the time of the last successful communication session; and
extracting the data from the company system.

12. A system for automating the process of gathering and updating relationship data, the system comprising a data center for querying a server of a company, wherein the data center initiates a communication session with the server and selects the communication protocol corresponding to the server and pulls the relationship data from the server and stores that information in memory.

13. The system of claim 12 wherein the data center includes a protocol module for selecting the protocol that corresponds to the protocol of the server.

14. The system of claim 13 wherein the data center parses the email header information to extract relationship data.
